(19) United States
(12) Patent Application Publication
(10) Pub. No.: US 2024/0160966 A1
(43) Pub. Date: May 16, 2024

(54) CREATING DECISION OPTIMIZATION SPECIFICATIONS

(71) Applicant: International Business Machines Corporation, Armonk, NY (US)

(72) Inventors: Yishai Abraham Feldman, Tel Aviv (IL); Eliezer Segev Wasserkrug, Haifa (IL); Aviad Sela, Yokneam (IL)

(21) Appl. No.: 17/986,973

(22) Filed: Nov. 15, 2022

(51) Int. Cl. G06N 5/045

(52) U.S. Cl. CPC G06N 5/045

(57) ABSTRACT

An approach is disclosed that receives a set of descriptive material with logic that verifies whether a solution satisfies one or more problem constraints. The descriptive material also computes a value of an objective function that is achieved. The approach generates an output to input to an optimization engine. The output is based on analyzing the set of descriptive material. The approach then processes the output with the optimization engine with the processing resulting in a set of optimization results.

### BACKGROUND

Optimization solvers help improve decision-making around planning, allocating and scheduling scarce resources. They embed powerful algorithms that can solve mathematical programming models, constraint programming and constraint-based scheduling models. Using optimization solvers often requires specialized knowledge held by optimization experts. Optimization experts are often scarce. As a result, many optimization problems are not solved using optimization solver software packages. Instead, many problems are approached manually resulting in sub-optimum results due to the difficulty in optimizing large, complex problems. Other problems are approached heuristically, also resulting in sub-optimal results.

### SUMMARY

An approach is disclosed that receives a set of descriptive material with logic that verifies whether a solution satisfies one or more problem constraints. The descriptive material also computes a value of an objective function that is achieved. The approach generates an output to input to an optimization engine. The output is based on analyzing the set of descriptive material. The approach then processes the output with the optimization engine with the processing resulting in a set of optimization results.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting an architecture to create decision optimization specifications;

FIG. 4 is a flowchart depicting overall steps taken to create decision optimization specifications;

FIG. 5 is a flowchart depicting steps taken to generate output suitable for input and use by an optimization engine; and

FIG. 6 is a flowchart depicting steps taken to transform the expressive power found in non-optimization type inputs to inputs that can be used by an optimization engine.

### DETAILED DESCRIPTION

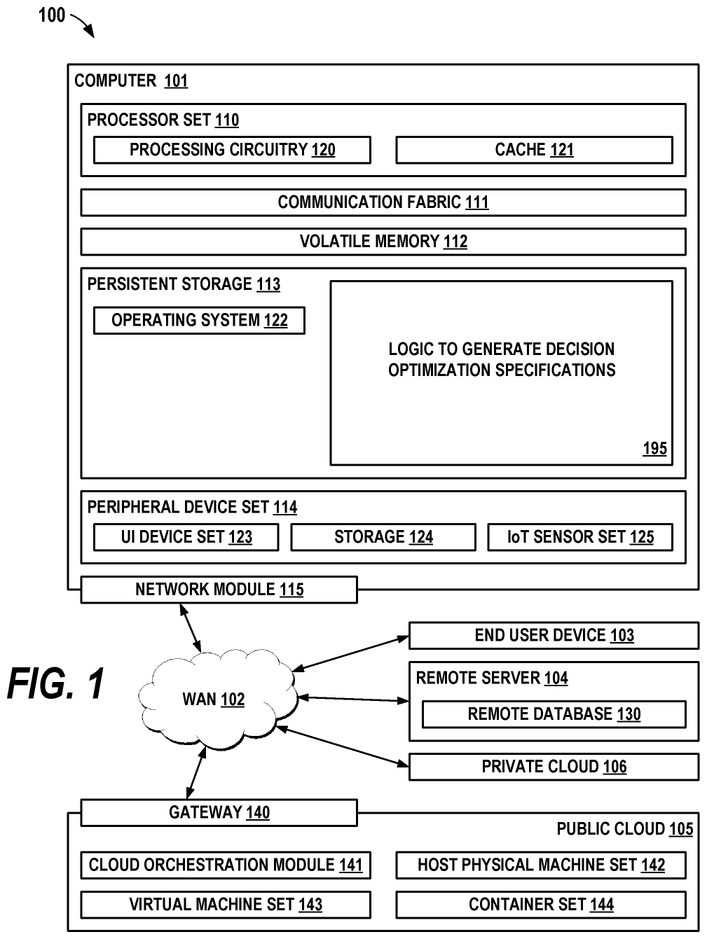

FIGS. 1-6 describe an approach that creates decision optimization specifications that can be used by an optimization engine. In general, writing a decision optimization specification for tools such as the IBM CPLEX™ product, often relies upon specialized knowledge, such as is held by optimization experts. These specifications can be written in domain-specific languages such as OPL (Optimization Programming Language) or the Python-embedded docplex (DOcplex is a native Python modeling library for optimization). They generally need a deep understanding of the algorithms that the solver applies to the specifications, in order to generate specifications that the solver can use to find a solution efficiently.

Optimization experts who are able to write these specifications are scarce, while enterprises have many optimization problems they need to solve. As a result, without the approach described herein, many of these problems are solved manually, with sub-optimal results, because of the limited capability of human experts to optimize very large problems. Other problems are solved heuristically by custom tools, again with sub-optimal results.

On the other hand, developers can much more easily write programs that verify a given solution to check that it conforms to the problem constraints, and compute the objective function (cost, income, profit, customer satisfaction, etc.). Such a program can be used for “what-if” analysis, regardless of any possible optimization. This activity is similar to a developer's typical programming tasks, and has the additional benefit that it is easy to find discrepancies between the intended and actual formulation of the optimization problem. This can be done, for, example, by inputting a sub optimal solution currently being used, and seeing whether the results conform to what currently happens and/or is expected.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

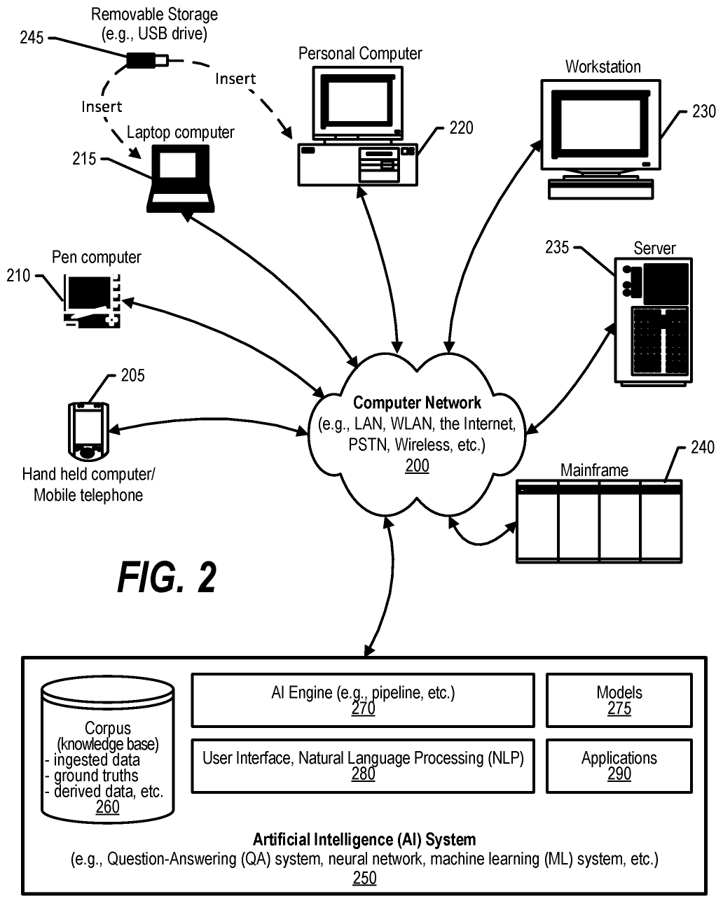

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code involved in performing the inventive methods, such as shown in the description of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users. Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available in order to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of AI modeling. AI modeling is the creation, training, and deployment of machine learning algorithms that emulate logical decision-making based on the data available in the corpus with the system sometimes utilizing additional data found outside the corpus. AI models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

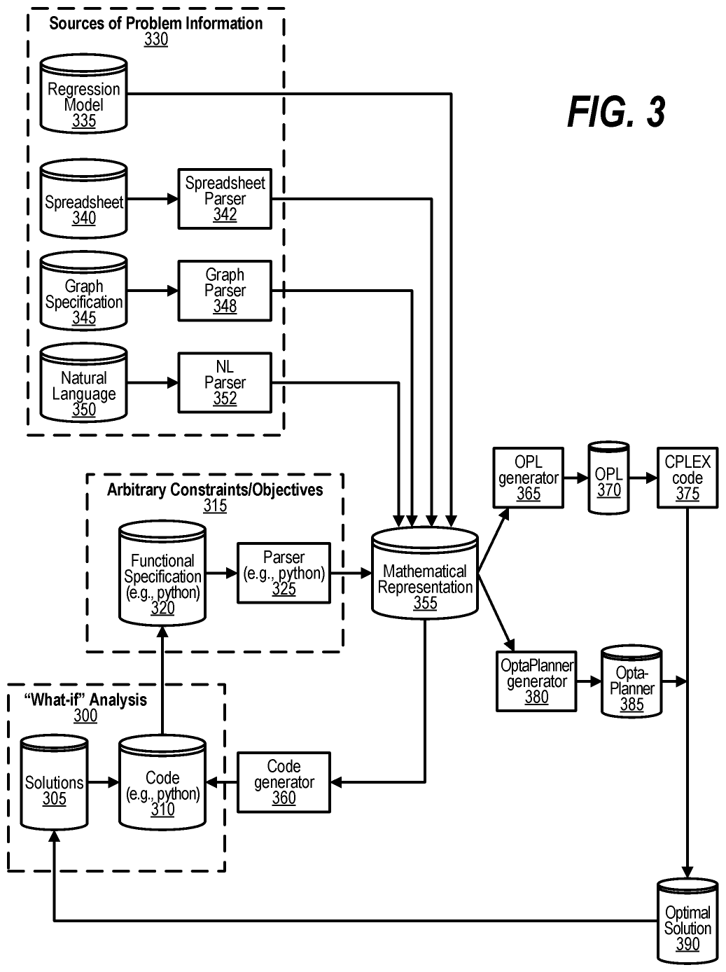

FIG. 3 is a component diagram depicting an architecture to create decision optimization specifications. The architecture of the approach is shown in FIG. 3. The approach described herein combines a manually-written verification program 310 (which may be partial) with code automatically generated from other sources of information 330, such as regression models 335, annotated graphs 345, spreadsheets 340, (restricted) natural language 350, or rules, to get a full verification program that can be used for what-if analysis 300 and for comparing solutions (solutions 305 being compared to each other or to a resulting “optimal” solution 390).

The code and other sources of information are referred to as “descriptive materials.” The approach analyzes the descriptive materials (e.g., program and other sources of information, etc.), and creates from them an optimization specification suitable for a solver such as CPLEX, by applying optimization expertise codified as rewrite rules. This makes it possible for developers without optimization expertise to solve enterprise optimization problems, making optimization technology much more widely accessible. In one embodiment, code 310, such as Python code, forms the basis of a functional specification of the problem that is stored in data store 320. Parser process 325 parses the functional specification into mathematical representations that are stored in data store 355.

The approach parses the verification program 320 together with other inputs 330 into an internal mathematical representation stored in data store 355. Then, a series of rewrite rules appropriate for the target is applied, converting the mathematical representation of the problem into one that conforms with the semantics and restrictions of the target language. While shown receiving inputs from other inputs 330 as well as verification program 320, any combination of one or more inputs can be used to generate mathematical representation 355. Finally, the resulting representation is directly encoded into the target language.

The mathematical representation is general-purpose, and supports mathematical and logical operators, including quantification and aggregation. Two major technologies are built over the mathematical representation: (1) rewrite rules with a pattern language; and (2) constraint propagation over the AST and data-flow graphs. These mechanisms are used to analyze and transform the mathematical representation of the source program into a form suitable for the target solver.

As shown, inputs, such as verification program 320 and/or other inputs 330 that are sources of information describing the problem can be combined to generate mathematical representation 355. For example, in an optimization problem that concerns some kind of process flow (manufacturing, supply chain, business process), the approach adds an annotated graph 345 that describes the process flow and associated attributes (which are converted into constraints and objectives). When parts of the process are too difficult to describe manually in closed form, the approach incorporates regression models 335, suitably converted into a set of linear (in)equalities. Any input that is not already executable verification code can be translated into such code and combined with existing code in order to create a full verification program.

The various inputs are shown being input to data store 355 and are the descriptive materials that drive the approach. In the example shown, these descriptive materials include regression models 335, spreadsheet 340, an annotated graph 345, and natural language 355 that describe a process, and custom code 310 that computes custom constraints (or possibly objectives) that cannot be expressed in other ways. Parser processes are used to parse the information into mathematical representations that are included in data store 355 (spreadsheet parser 342 parses spreadsheet data from spreadsheet 340, graph parser 348 parses graph data from graph 345, and natural language parser 352 parses natural language data from natural language 350).

Descriptive material inputs are converted into a common internal representation stored in data store 355. This mathematical representation supports analysis operations such as rewriting transformations and constraint propagation. The particular operations performed on this representation vary, depending on the target.

One possible target is an optimization solver such as CPLEX, and domain-specific analyses and transformations need to be carried out to make it possible to translate the resulting internal representation into the solver's language (OPL or docplex in this example). To output to CPLEX code 375, OPL generator 365 generates OPL that is stored in data store 370 with the OPL generator using the mathematical representations from data store 355 as input.

Another possible target is OptaPlanner™ which is a lightweight, embeddable planning engine. OptaPlanner generator 380 takes the mathematical representations stored in data store 355 as inputs and generates OptaPlanner output 385 that can be processed by an OptaPlanner engine. The result of the optimization process (e.g., CPLEX optimizer, OptaPlanner, etc.) is stored as a possible optimal solution in data store 390.

In one embodiment, the process can be iterative in that the generated optimal solution can be used in “what-if” analysis as a possible solution. The solutions stored in data store 305 can be altered and further analyzed by revising the functional code stored in data store 310 that is used to generate functional specification material that is stored in data store 320. In addition, the mathematical representations stored in data store 355 can be processed with code generator process 360 to also generate code that is stored in data store 310 and used as functional specification material. In one embodiment, the mathematical representations used to generate code is infused with other sources of problem information 330, such as regression models, spreadsheets, graph specifications, and natural language inputs.

As mentioned, a possible target is a conventional programming language such a Python. In this scenario, the graph and regression-model inputs are combined with information from the user program in order to convert the other inputs into a form that can be combined with the user program, so that it can be used to verify or compare solutions with all the problem information.

The following is an example specification of a room-allocation program in the functional subset of Python supported by the approach described herein:

```
import math
from typing import NewType, Tuple
from optimistic_client.meta.utils import count,
constraint, minimize, record, solution_variable
from optimistic_client.optimization import
OptimizationProblem, TotalMapping
Area = NewType(′Area′, int)
Floor = NewType(′Floor′, str)
EmployeeType = NewType(′EmployeeType′, str)
OfficeType = NewType(′OfficeType′, str)
EmployeeId = NewType(′EmployeeId′, str)
@record
class OfficeTypeInfo:
  max_occupancy: int
  cost: float
@record
class EmployeeData:
  type: EmployeeType
  team_lead: EmployeeId
  is_team_lead: bool
  is_independent: bool
  area: Area
class RoomAllocationProblem9(OptimizationProblem):
  ”””
  Optimization problem of allocating employees to
offices.
  ”””
  employees: TotalMapping[EmployeeId, EmployeeData]
  building: TotalMapping[Tuple[Floor, OfficeType], int]
  office_type_by_employee_type:
TotalMapping[EmployeeType, OfficeType]
  office_info: TotalMapping[OfficeType, OfficeTypeInfo]
  solution: TotalMapping[EmployeeId, Floor] =
solution_variable( )
  def all_floors(self):
    return {a[0] for a in self.building.keys( )}
  def all_areas(self):
    return {e.area for e in self.employees.values( )}
  def all_office_types(self):
    return
set(self.office_type_by_employee_type.values( ))
  @constraint
  def same_floor(self):
    ”””
    Each employee must be assigned to the same floor
as his/her team lead unless the team lead is independent
    ”””
    return all(self.solution[emp_id] ==
self.solution[emp_data.team_lead]
      for emp_id, emp_data in
self.employees.items( )
      if not
self.employees[emp_data.team_lead].is_independent)
  def occupancy(self, f1: Floor, o1):
    ”””
    How many employees who need to be in offices of
type o1 are placed on floor f1
    ”””
    return count(emp_id for emp_id, emp_data in
self.employees.items( )
        if
self.office_type_by_employee_type[emp_data.type] == o1
        and self.solution[emp_id] == f1)
  @constraint
  def availability_constraint(self):
    return all(self.occupancy(f1, o1)
      <= self.office_info[o1].max_occupancy
* self.building[f1, o1]
      for o1 in self.all_office_types( )
      for f1 in self.all_floors( ))
  def assigned_offices(self, o1: OfficeType, f1: Floor)
-> int:
    return math.ceil(self.occupancy(f1, o1) /
self.office_info[o1].max_occupancy)
  @minimize
  def cost_objective(self):
    return sum(self.assigned_offices(o1, f1) *
self.office_info[o1].cost
      for o1 in self.all_office_types( )
      for f1 in self.all_floors( ))
  def area_utilization(self, area, f1: Floor):
    return count(emp_id for emp_id, emp_data in
self.employees.items( )
        if emp_data.area == area and
self.solution[emp_id] == f1)
  def area_penalty(self, area: Area, f1: Floor):
    return 0 if self.area_utilization(area, f1) == 0
else 1
  @minimize(weight=20000)
  def area_objective(self):
    ”””
    Minimize penalties of spreading areas over
multiple floors
    ”””
    return sum(self.area_penalty(a1, f1) for a1 in
self.all_areas( ) for f1 in self.all_floors( ))
```

The following is an example of the transformation of a snippet of functional Python code into a corresponding OPL code by applying a series of transformations:

x=(0 if a<b else 1)

$x=($a<$b?0:1)initial translation

$x=(($a<$b⇒0)\hat{ }(($a<$b)⇒1))Conditional eliminated

$x=(($a<$b⇒0)\hat{ }($a≥$b⇒1)Negation pushed into comparison

$x=(($a≤$b−ε⇒0)\hat{ }($a≥$b⇒1))Strict inequalities eliminated

$x=($a≤$b−ε⇒0)\hat{ }$x=($a≥$b⇒1)Conjunction lifted

($a≤$b−ε⇒$x=0)\hat{ }$x=($a≥$b⇒1)Left implication lifted

($a≤$b−ε⇒$x=0)\hat{ }($a≥$b⇒$x=1)Right implication lifted

(a°=b−1e-10=>x==0)&&(a>=b=>x==1)OPL code

In order to perform some of the transformations, the approach infers some properties of the program (or rather, its mathematical representation). These include types (which are optional in Python); domains (for example, the fact that a variable ranges over a range of numbers); dependences between variables (for example, variables that depend on something that is subject to computation by the solver need to be defined as decision variables). These inferences are interdependent; for example, a type can affect the inferred domain and vice versa. This inference is carried out through a set of constraints on the network that represents relationships between elements of the mathematical representation, written in such a way that information will be propagated over this network regardless of the order in which it arrives.

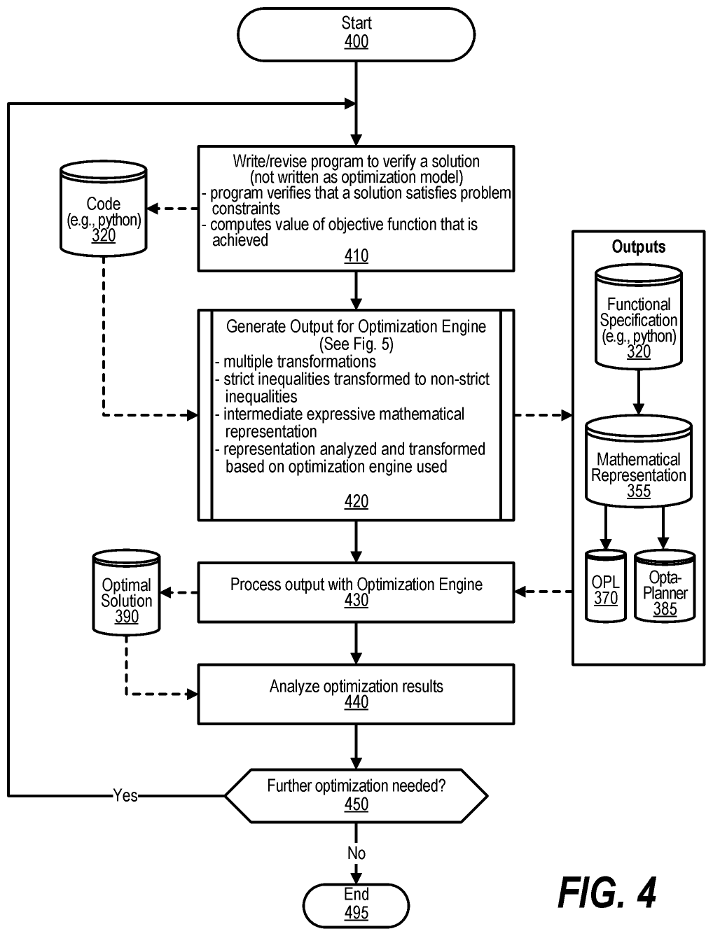

FIG. 4 is a flowchart depicting overall steps taken to create decision optimization specifications. Processing commences at 400 whereupon, at step 410, the user of the process writes or revises descriptive material that verifies a solution. The descriptive material, such as a computer program, is not written as an optimization model but, instead, verifies that a solution satisfies the given problem's constraints. In addition, the program computes a value of an objective function that is achieved. The program code is stored in data store 310.

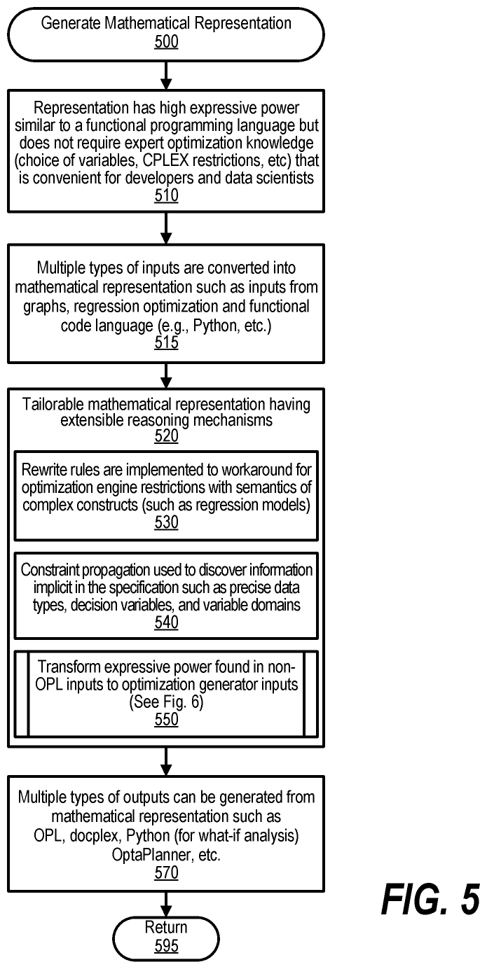

At predefined process 420, the process performs the Generate Output for Optimization Engine routine (see FIG. 5 and corresponding text for examples of how such output can be generated). The routine takes descriptive material (e.g., the code from data store 310 as well as any other descriptive material (e.g., regression models, spreadsheets, etc.) that were discussed in FIG. 3) and generates the outputs shown. These outputs include functional specification 320 that is created from the program code, mathematical representation 355 that is generated from the functional specification as well as from any other descriptive material. Predefined process 420 performs multiple transformation. For example, strict inequalities from the code and other descriptive materials are transformed to non-strict inequalities used in optimization program languages. Further, the routine generates an intermediate expressive mathematical representation and analyzes the representation and transformations based on the optimization engine that is being used.

Predefined process 420 generates optimization language files (e.g., OPL 370 and/or OptaPlanner 385, etc.). At step 430, the output optimization language is used as an input to the Optimization Engine that is being used by the organization. The result of the Optimization Engine processing is an optimal solution that is stored in data store 390.

At step 440, the optimal solution data is analyzed, for example to determine if the solution complete and correct, or if further optimization is needed. If further optimization is needed, decision 450 branches to the ‘yes’ branch which loops back to revise the program code and other descriptive materials that might be used during the generation of the output for the optimization engine. This looping continues until further optimization is no longer needed, at which point decision 450 branches to the ‘no’ branch and processing ends at 495.

FIG. 5 is a flowchart depicting steps taken to generate output suitable for input and use by an optimization engine. FIG. 5 processing commences at 500 and shows the steps taken by a process that generate Mathematical Representation. At step 510, the process begins on the mathematical representations that have high expressive power similar to a functional programming language but does not require expert optimization knowledge (choice of variables, CPLEX restrictions, etc.). This is convenient for developers and data scientists without advanced knowledge of writing optimization language files.

At step 515, the process converts multiple types of inputs into mathematical representations, such as inputs from graphs, regression optimization and functional code language (e.g., Python, etc.).

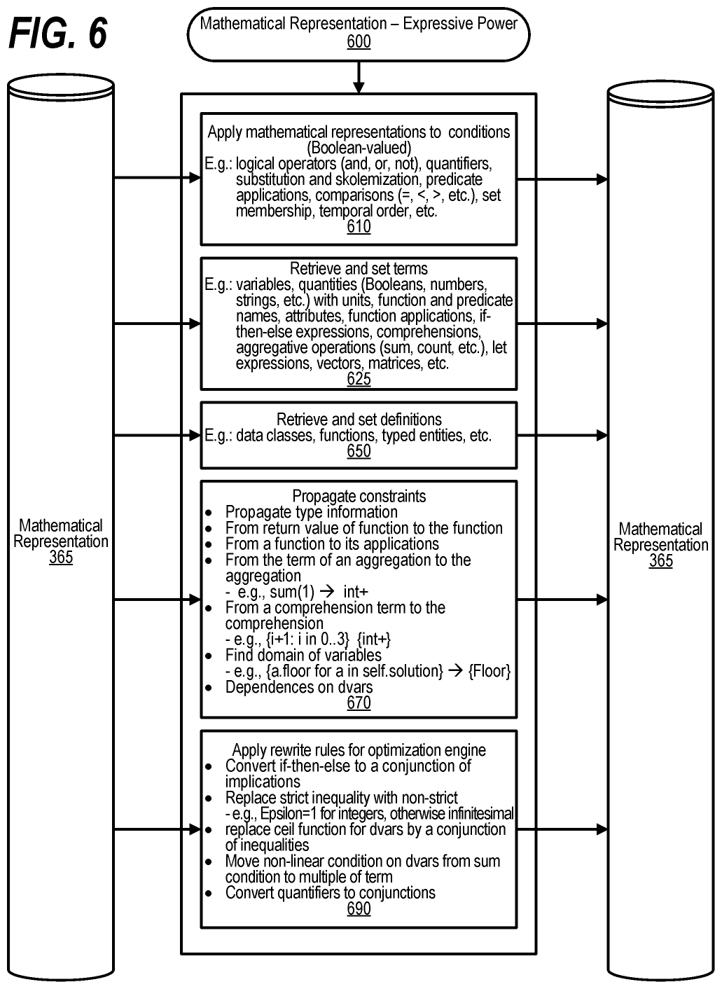

At step 520, the process handles the tailorable mathematical representation that has extensible reasoning mechanisms using steps 530 through 550. At step 530, the process applies rewrite rules that are implemented to work around optimization engine restrictions with semantics of complex constructs (such as regression models). At step 540, the process propagates constraints that are used to discover information implicit in the specification such as precise data types, decision variables, and variable domains. At predefined process 550, the process transforms the expressive power found in non-OPL inputs to optimization generator inputs (see FIG. 6 and corresponding text for additional details).

At step 570, the process generates multiple types of outputs from the mathematical representation such as OPL, docplex, Python (for what-if analysis) OptaPlanner, etc. FIG. 5 processing thereafter returns to the calling routine (see FIG. 4) at 595.

FIG. 6 is a flowchart depicting steps taken to transform the expressive power found in non-optimization type inputs to inputs that can be used by an optimization engine. FIG. 6 processing commences at 600. The steps shown are each performed as needed based on the current form of the mathematical representation that is being input and need not be sequential, as shown for simplicity, in the diagram. At step 610, the process applies mathematical transformations to conditions (Boolean-valued) with the mathematical representations being retrieved from original mathematical representations that are stored in data store 365. This includes logical operators (and, or, not), quantifiers, substitution and skolemization, predicate applications, comparisons (=, <, >, etc.), set membership, temporal order, etc. The results of step 610 are used to update the mathematical representations shown being output to the right into data store 365.

At step 625, the process retrieves and sets terms. For example, variables, quantities (Booleans, numbers, strings, etc.) with units, function and predicate names, attributes, function applications, if-then-else expressions, comprehensions, aggregative operations (sum, count, etc.), let expressions, vectors, matrices, etc. The terms are retrieved from mathematical representations 365 shown as inputs to step 625 that are then updated as shown with step 625 updating mathematical representations 365 with its output.

At step 650, the process retrieves and set definitions, e.g., data classes, functions, typed entities, etc. The definitions data are retrieved from mathematical representations 365 shown as inputs to step 650 that are then updated as shown with step 650 updating mathematical representations 365 with its output.

At step 670, the process propagates constraints. The propagation includes propagate type information; from return value of function to the function; from a function to its applications; from the term of an aggregation to the aggregation; from a comprehension term to the comprehension; in finding the domain of variables; and dependences on decision variables. The propagation data are retrieved from mathematical representations 365 shown as inputs to step 670 that are then updated as shown with step 670 updating mathematical representations 365 with its output.

At step 690, the process applies rewrite rules for the optimization engine that is being used. These rewrite rules include converting if-then-else to a conjunction of implications, replacing strict inequalities with non-strict inequalities, replacing ceil function for decision variables by a conjunction of inequalities, moving non-linear conditions on decision variables from sum condition to multiple of term, and converting quantifiers to conjunctions. The data processed by the rewrite rules are retrieved from mathematical representations 365 shown as inputs to step 690 that are then updated as shown with step 690 updating mathematical representations 365 with its output. Processing then returns to the processing shown in FIG. 5.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, performed by an information handling system that includes a processor and a memory accessible by the processor, the method comprising:
receiving a set of descriptive material with logic that verifies whether a solution satisfies one or more problem constraints and computes a value of an objective function that is achieved;
generating an output to input to an optimization engine, the output based on analyzing the set of descriptive material; and
processing the output with the optimization engine resulting in a set of optimization results.

2. The method of claim 1 further comprising:
transforming the set of descriptive material to a tailorable mathematical representation that has extensible reasoning mechanisms, the transforming including:
receiving a set of rules corresponding to the optimization engine, wherein the rules include semantics of complex constructs used by the optimization engine; and
rewriting the set of descriptive material using the received set of rules.

3. The method of claim 2 further comprising:
propagating one or more constraints found in the set of descriptive material, the propagating resulting in discovery of information implicit in the set of descriptive material, the information including data types, decision variables, and variable domains; and
transforming an expressive power found in a set of inputs corresponding to the set of descriptive material to a set of optimization generator inputs.

4. The method of claim 2 further comprising:
converting one or more external models into the mathematical representation, wherein at least one of the external models is selected from the group consisting of a regression model, a spreadsheet model, a graph specification model, and a natural language input model.

5. The method of claim 2 further comprising:
after converting the external models into the mathematical representation, generating a second set of descriptive material from the mathematical representation.

6. The method of claim 2 further comprising:
generating a plurality of sets of optimization outputs from the mathematical representation, wherein a first of the sets corresponds to the optimization engine and a second of the sets corresponds to a second optimization engine.

7. The method of claim 2 further comprising:
converting an if-then-else construct found in the set of source code to a conjunction of implications that is included in the output;
replacing a strict inequality found in the set of source code to a non-strict inequality form that is included in the output; and
converting a quantifier found in the set of source code to a conjunction that is included in the output.

8. An information handling system comprising:
one or more processors;
a memory coupled to at least one of the processors; and
a set of instructions stored in the memory and executed by at least one of the processors to perform actions comprising:
receiving a set of descriptive material with logic that verifies whether a solution satisfies one or more problem constraints and computes a value of an objective function that is achieved;
generating an output to input to an optimization engine, the output based on analyzing the set of descriptive material; and
processing the output with the optimization engine resulting in a set of optimization results.

9. The information handling system of claim 8 wherein the actions further comprise:
transforming the set of descriptive material to a tailorable mathematical representation that has extensible reasoning mechanisms, the transforming including:
receiving a set of rules corresponding to the optimization engine, wherein the rules include semantics of complex constructs used by the optimization engine; and
rewriting the set of descriptive material using the received set of rules.

10. The information handling system of claim 9 wherein the actions further comprise:
propagating one or more constraints found in the set of descriptive material, the propagating resulting in discovery of information implicit in the set of descriptive material, the information including data types, decision variables, and variable domains; and
transforming an expressive power found in a set of inputs corresponding to the set of descriptive material to a set of optimization generator inputs.

11. The information handling system of claim 9 wherein the actions further comprise:
converting one or more external models into the mathematical representation, wherein at least one of the external models is selected from the group consisting of a regression model, a spreadsheet model, a graph specification model, and a natural language input model.

12. The information handling system of claim 9 wherein the actions further comprise:
after converting the external models into the mathematical representation, generating a second set of descriptive material from the mathematical representation.

13. The information handling system of claim 9 wherein the actions further comprise:
generating a plurality of sets of optimization outputs from the mathematical representation, wherein a first of the sets corresponds to the optimization engine and a second of the sets corresponds to a second optimization engine.

14. The information handling system of claim 9 wherein the actions further comprise:
converting an if-then-else construct found in the set of source code to a conjunction of implications that is included in the output;
replacing a strict inequality found in the set of source code to a non-strict inequality form that is included in the output; and
converting a quantifier found in the set of source code to a conjunction that is included in the output.

15. A computer program product comprising:
a computer readable storage medium comprising a set of computer instructions, the computer instructions effective to perform actions comprising:
receiving a set of descriptive material with logic that verifies whether a solution satisfies one or more problem constraints and computes a value of an objective function that is achieved;
generating an output to input to an optimization engine, the output based on analyzing the set of descriptive material; and
processing the output with the optimization engine resulting in a set of optimization results.

16. The computer program product of claim 15 wherein the actions further comprise:
transforming the set of descriptive material to a tailorable mathematical representation that has extensible reasoning mechanisms, the transforming including:
receiving a set of rules corresponding to the optimization engine, wherein the rules include semantics of complex constructs used by the optimization engine; and
rewriting the set of descriptive material using the received set of rules.

17. The computer program product of claim 16 wherein the actions further comprise:
propagating one or more constraints found in the set of descriptive material, the propagating resulting in discovery of information implicit in the set of descriptive material, the information including data types, decision variables, and variable domains; and
transforming an expressive power found in a set of inputs corresponding to the set of descriptive material to a set of optimization generator inputs.

18. The computer program product of claim 16 wherein the actions further comprise:
converting one or more external models into the mathematical representation, wherein at least one of the external models is selected from the group consisting of a regression model, a spreadsheet model, a graph specification model, and a natural language input model.

19. The computer program product of claim 16 wherein the actions further comprise:
generating a plurality of sets of optimization outputs from the mathematical representation, wherein a first of the sets corresponds to the optimization engine and a second of the sets corresponds to a second optimization engine.

20. The computer program product of claim 16 wherein the actions further comprise:
converting an if-then-else construct found in the set of source code to a conjunction of implications that is included in the output;
replacing a strict inequality found in the set of source code to a non-strict inequality form that is included in the output; and
converting a quantifier found in the set of source code to a conjunction that is included in the output.
